(19) United States
(12) Patent Application Publication
(10) Pub. No.: US 2020/0053472 A1
(43) Pub. Date: Feb. 13, 2020

(54) SPEAKER

(71) Applicant: AAC Technologies Pte. Ltd., Singapore (SG)

(72) Inventors: Bo Xiao, Shenzhen (CN); Chengming Cao, Shenzhen (CN)

(21) Appl. No.: 16/528,683

(22) Filed: Aug. 1, 2019

(30) Foreign Application Priority Data
Aug. 9, 2018 (CN) 201821278037.0

(51) Int. Cl. H04R 9/04; H04R 9/02

(52) U.S. Cl. CPC H04R 9/046; H04R 9/025

(57) ABSTRACT

The present disclosure provides a speaker, comprising a basin frame with a receiving space, a vibration system disposed at the basin frame, and a magnetic circuit system configured for driving the vibration system to vibrate and thus generate sound, wherein, the vibration system comprises a sound radiation plate, a flexible circuit board for elastically supporting the sound radiation plate and a voice coil disposed at a lower side of the flexible circuit board, the flexible circuit board comprises coating layers laminated apart and a copper layer sandwiched between two adjacent coating layers, the coating layers are poly ether ether ketone layers and/or a thermoplastic polyurethane elastomer layers. The speaker provided by the present disclosure has a vibration system with a smaller mass, a higher sensitivity and a reduced cost.

### TECHNICAL FIELD

The present disclosure relates to the field of electro-acoustic conversion, in particular to a speaker.

### BACKGROUND

With the rapid development of wireless communication, mobile phones are widely used in the world. The demand for mobile phones is not limited to basic calls, but more requirements on the reliability of traditional mobile phones are put forward. Especially as 3G times is coming, mobile multimedia technology has also developed, and many mobile phones have a variety of entertainment functions, such as video playback, digital camera, games, GPS navigation.

The speakers according to the related art are generally provided with a basin frame, a vibration system and a magnetic circuit system. The magnetic circuit system includes a magnetic bowl provided with a magnetic bowl side wall and a magnetic steel assembled in the magnetic bowl and forming a magnetic gap with the magnetic bowl, the vibration system includes a diaphragm, a flexible circuit board fixed to the diaphragm and a voice coil, the voice coil is suspended in the magnetic gap. The flexible circuit board is made of polyimide material and copper material, and the flexibility is poor.

Therefore, it is necessary to provide a new speaker to solve the above technical problems.

### BRIEF DESCRIPTION OF THE DRAWINGS

In order to more clearly describe the technical solutions in the embodiments of the present disclosure, the drawings used in the description of the embodiments will be briefly described below. It is obvious that the drawings in the following description only relate to some embodiments of the present disclosure. For those skilled in the art, other drawings may also be obtained according to the accompanying drawings without any creative work, wherein:

FIG. 1 is a schematic exploded view illustrating a speaker according to the present disclosure;

FIG. 2 is a section view illustrating a speaker according to the present disclosure;

FIG. 3 is a structural diagram illustrating the flexible circuit board according to the present disclosure.

### DETAILED DESCRIPTION

The technical solutions in the embodiments of the present disclosure are clearly and completely described in the following with reference to the accompanying drawings in the embodiments of the present disclosure. It is obvious that the described embodiments are only a part of the embodiments of the present disclosure, but not all of the embodiments. All other embodiments obtained by those skilled in the art based on the embodiments of the present disclosure without creative work fall within the scope of the present disclosure.

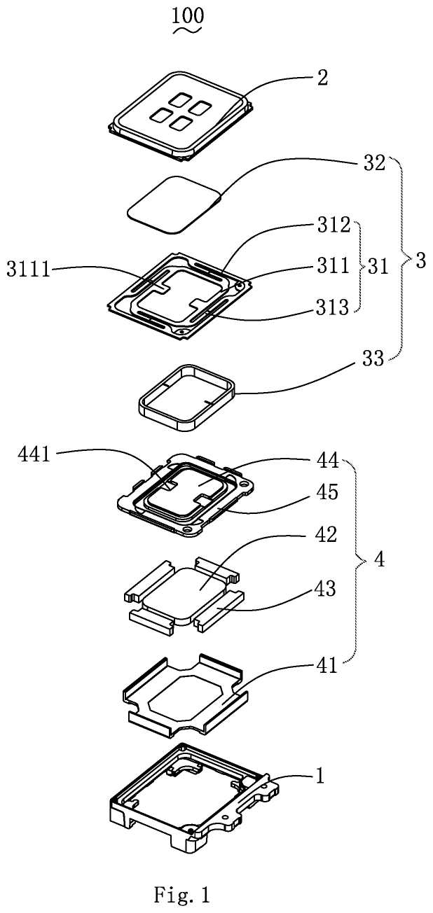

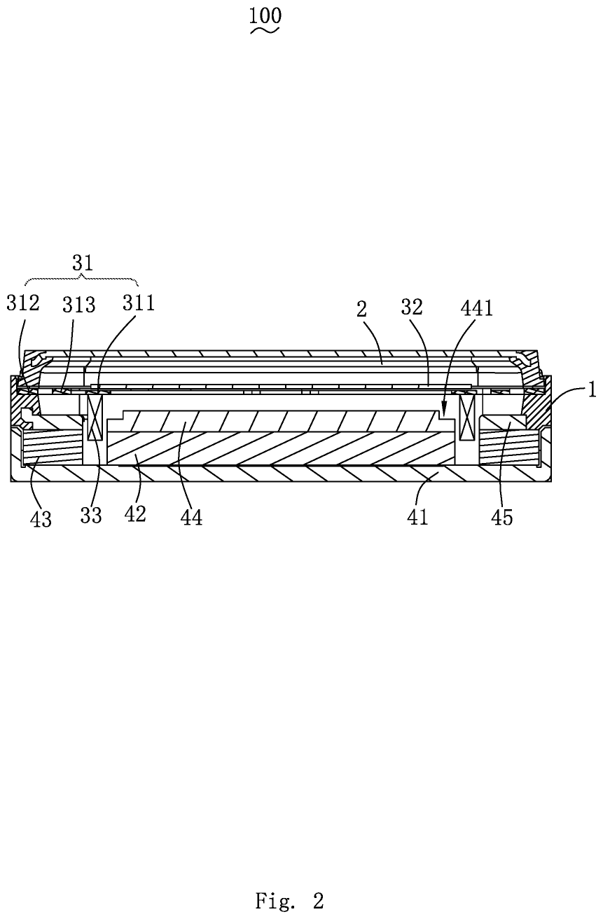

Referring to FIGS. 1 and 2, the speaker 100 includes a basin frame 1, a front cover 2, a vibration system 3, and a magnetic circuit system 4.

The basin frame 1 has a receiving space for receiving the vibration system 3 and the magnetic circuit system 4.

The front cover 2 is configured to fit with the basin frame 1 to form the receiving space.

The vibration system 3 includes a sound radiation plate 32, a flexible circuit board 31 configured to elastically support the sound radiation plate 32, and a voice coil 33 disposed at a lower side of the flexible circuit board 31. The sound radiation plate 32 may be a part of the flexible circuit board 31, or a member fixed on the flexible circuit board 31 like a dome of a conventional diaphragm.

The flexible circuit board 31 includes a support portion 311 located at the center of the flexible circuit board 31 for supporting the sound radiation plate 32, a fixing portion 312 disposed around the outer periphery of the support portion 311 and fixedly held by the basin frame 1, and an elastic arm 313 for connecting the support portion 311 and the fixing portion 312.

A side of the support portion 311 away from the elastic arm 313 is further provided with a protruding portion 3111, the protruding portion is configured to be a welding portion for welding with a lead of the voice coil 33.

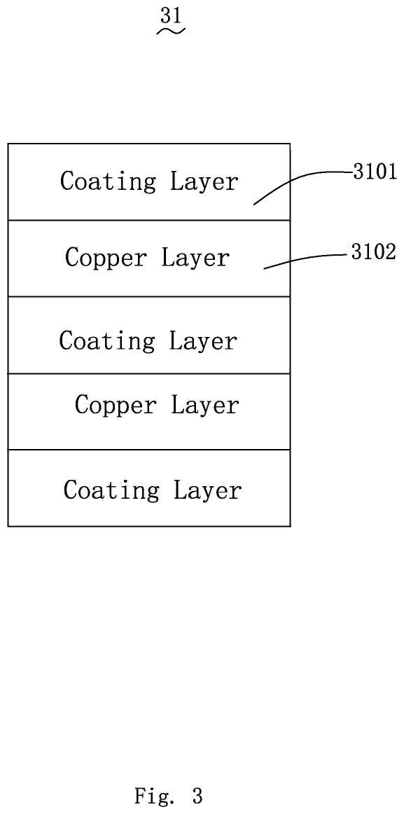

Referring to FIG. 3, the flexible circuit board 31 includes coating layers 3101 laminated at intervals and a copper layer 3102 sandwiched between two adjacent coating layers 3101. The coating layers 3101 are poly ether ether ketone layers and/or a thermoplastic polyurethane elastomer layers. Specifically, the flexible circuit board includes three coating layers, and two copper layers 3102.

Through forming the flexible circuit board 31 by stacking poly ether ether ketone layers/thermoplastic polyurethane elastomer layers and copper layers, the flexibility of the flexible circuit board 31 may be enhanced, and the flexible circuit board 31 possess relevant characteristics and functions of the diaphragm, thus it may replace the original diaphragm, and therefore there is no necessity to provide a diaphragm.

Therefore, in manufacturing the speaker 100, the assembly process may be simplified, the cost may be reduced, and the efficiency may be improved; and the mass of the vibration system is reduced, and the sensitivity of the product may be improved, thereby ensuring good acoustic performance.

The magnetic circuit system 4 includes a magnetic bowl 41, a primary magnetic steel 42 assembled in the magnetic bowl 41, a secondary magnetic steel 43 spaced apart from the main magnetic steel to form a magnetic gap, and a main pole core 44 and a sub-pole core 45 respectively adhered to the main magnetic steel 42 and the secondary magnetic steel 43. One end of the voice coil 33 is fixedly held by the flexible circuit board 31, and the other end is suspended in the magnetic gap. A magnetic field, generated in the magnetic gap by the main magnetic steel 42 and the secondary magnetic steel 43, interacts with the voice coil 33 to generate a driving force for driving the voice coil 33 to reciprocate, thereby driving the flexible circuit board 31 to vibrate, and then the flexible circuit board 31 drives the sound radiation plate 32 to vibrate and thus generate sound.

A side of the main pole core 44 corresponding to the sound radiation plate 32 is provided with a recessed portion 441, and the recessed portion 441 is disposed right opposite to and spaced apart from the protruding portion 3111. In this way, it is possible to prevent the lead from being detached from the protruding portion 3111 in reciprocating motions of the voice coil 33, so that the connection is more stable.

Compared with the related art, the flexible circuit board of the speaker in the present disclosure adopts a stack structure of a poly ether ether ketone layer/a thermoplastic polyurethane elastomer layer and a copper layer, so that the flexible circuit board is more flexible, which could replace the original diaphragm, thus there is no necessity to provide a diaphragm, thereby, the assembly process may be simplified, the cost may be reduced, and the efficiency may be improved; and the mass of the vibration system could be reduced, and the sensitivity of the product may be improved, thereby ensuring good acoustic performance.

The above description only illustrates the embodiments of the present disclosure. It should be noted that those skilled in the art may make improvements thereto without departing from the inventive concept of the present disclosure, which shall be considered as falling within the protection scope of the present disclosure.

What is claimed is:

1. A speaker comprising: a basin frame having a receiving space, a vibration system disposed at the basin frame, and a magnetic circuit system configured for driving the vibration system to vibrate and thus generate sound, wherein, the vibration system comprises a sound radiation plate, a flexible circuit board for elastically supporting the sound radiation plate and a voice coil disposed at a lower side of the flexible circuit board, the flexible circuit board comprises coating layers laminated apart and a copper layer sandwiched between two adjacent coating layers, the coating layers are poly ether ether ketone layers and/or a thermoplastic polyurethane elastomer layers.

2. The speaker according to claim 1, wherein, the flexible circuit board comprises a support portion located at a center of the flexible circuit board for supporting the sound radiation plate, a fixing portion disposed around outer periphery of the support portion and fixedly held by the basin frame, and an elastic arm for connecting the support portion and the fixing portion.

3. The speaker according to claim 2, wherein a side of the support portion away from the elastic arm is provided with a protruding portion.

4. The speaker according to claim 1, wherein the flexible circuit board comprises three coating layers and two copper layers.

5. The speaker according to claim 1, wherein the magnetic circuit system comprises a magnetic bowl, a main magnetic steel fixedly held in the magnetic bowl, a secondary magnetic steel spaced apart from the main magnetic steel to form a magnetic gap, and a main pole core and a secondary pole core respectively adhered to the main magnet and the secondary magnet, wherein, one end of the voice coil is fixed to the flexible circuit board and the other end of the voice coil is suspended in the magnetic gap.

6. The speaker according to claim 1, wherein the speaker further comprises a front cover fitted with the basin frame.
